(19) United States
(12) Patent Application Publication
(10) Pub. No.: US 2010/0312417 A1
(43) Pub. Date: Dec. 9, 2010

(54) VEHICLE-MOUNTED ELECTRONIC SYSTEM

(75) Inventors: Tetsuaki WAKABAYASHI, Toyota-shi (JP); Soichiro ARAI, Okazaki-shi (JP); Hiroyasu NISHIUMI, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: TOYOTA JIDOSHA KABUSHIKI KAISHA, Toyota-shi (JP); DENSO CORPORATION, Kariya-city (JP); Renesas Electronics Corporation, Kawasaki (JP)

(21) Appl. No.: 12/792,329

(22) Filed: Jun. 2, 2010

(30) Foreign Application Priority Data
Jun. 5, 2009 (JP) 2009-135970

(51) Int. Cl. G06F 7/00

(52) U.S. Cl. 701/1

(57) ABSTRACT

A vehicle-mounted electronic system includes: a standby ECU that performs standby operation when ignition is turned off; a plurality of non-standby ECUs that are inactive when the ignition is turned off; a sensor electric wire that is disposed between the plurality of sensors and the standby ECU to supply power from the standby ECU to the plurality of sensors; a sensor signal wire that carries a signal from the plurality of sensors to the standby ECU; and an ECU signal wire that is disposed between the non-standby ECU and the standby ECU to carry a wakeup request signal from the standby ECU to the non-standby ECU, in which the standby ECU, in response to signal input from the sensor, transmits the wake up request signal through the ECU signal wire to the non-standby ECU that corresponds to the signal from the sensor.

### INCORPORATION BY REFERENCE

The disclosure of Japanese Patent Application No. 2009-135970 filed on Jun. 5, 2009 including the specification, drawings and abstract is incorporated herein by reference in its entirety.

### BACKGROUND OF THE INVENTION

1. Field of the Invention

The present invention relates to vehicle-mounted electronic system that includes a standby electronic control unit (ECU) that enters a standby mode when the ignition switch is turned off (standby operation).

2. Description of the Related Art

For example, Japanese Patent Application Publication No. 2002-67834 (JP-A-2002-67834) describes a vehicle information communication system. In the described system, when the ignition switch is turned off, a durable HDD and a nonvolatile memory (e.g. EEPROM), which requires no power, are preferentially used to store information about manual operation by a user, so that the number of microcomputers that consumes dark current is reduced and power consumption after the ignition switch is turned off is reduced.

Recently, vehicle-mounted electronic systems include many ECUs. Some of the ECUs continue to operate when the vehicle is stationary (i.e. when the ignition switch is turned off and thus an engine is not running). Hereinafter, the state in which the ignition switch is turned off and the engine is not running is also referred to as “standby mode”, the state in which the ignition switch is turned off is also referred to as “ignition-off state”, and the state in which the ignition switch is turned on is also referred to as “ignition-on state.” The ECUs that continue to operate when the vehicle is stationary are typically used to detect the approach of a user to the vehicle or to periodically detect various conditions, ouch as temperature and pressure.

In general, when the vehicle is being operated, sufficient electric power is usually maintained because an alternator generates electric power and a regenerative brake collects electric power. However, in the standby mode, no power-generating source is active, and the power is supplied from only a battery. As the total power consumption of the ECUs that continue to operate when the vehicle is in the standby mode increase, the battery runs down more easily, for example, when the vehicle is not used for a long time or experiences long time transport. In particular, the number of ECUs that continue to operate (the number of functions that are fulfilled during the standby mode) tends to increase because the number of standby functions in vehicles have increased, for example, including an access light is lit when the user approaches and a monitoring function that monitors the subject devices during the standby mode.

### SUMMARY OF THE INVENTION

The present invention provides vehicle-mounted electronic systems consume less power in a standby mode in order to cope with the increasing number of functions to be performed in the standby mode.

A first aspect of the present invention relates to a vehicle-mounted electronic system. The vehicle-mounted electronic system includes: a plurality of sensors in which at least two sensors continue to operate after an ignition is turned off; and a plurality of ECUs, wherein a power supply wire and a signal wire of the at least two sensors are connected to at least one ECU of the plurality of ECUs; a number of the at least one ECU is less than a number of ECU of the plurality of ECUs that is operated when the ignition is turned on; and the at least one ECU functions as a standby ECU when the ignition is turned off.

A second aspect of the present invention relates to a vehicle-mounted electronic system. The vehicle-mounted electronic system includes: a standby ECU that enters a standby mode when ignition is turned off; a plurality of non-standby ECUs that are respectively connected to a plurality of sensors that are operated when the ignition is turned off, wherein, the non-standby ECU is in a sleep state or an off state when the ignition is turned off; a sensor electric wire that connects the plurality of sensors to the standby ECU and through which power is supplied from the standby ECU to the plurality of sensors; a sensor signal wire that carries a signal from the plurality of sensors to the standby ECU; and an ECU signal wire that connects the plurality of non-standby ECU to the standby ECU, wherein the ECU signal wire carries a wakeup request signal from the plurality of standby ECU to the non-standby ECU, wherein the standby ECU, in response to signal input from the sensor, transmits the wake up request signal through the ECU signal wire to the non-standby ECU based on the signal from the sensor.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 shows a comparative example (reference example);

FIG. 2 shows a vehicle-mounted electronic system according to a first embodiment of the present invention;

FIG. 3 shows a vehicle-mounted electronic system according to a second embodiment of the present invention;

FIG. 4 shows a vehicle-mounted electronic system according to a third embodiment of the present invention;

FIG. 5 is a flow chart that shows an example of a main process executed by the vehicle-mounted electronic system according to each of the first to third embodiments;

FIG. 6 shows a vehicle-mounted electronic system according to a fourth embodiment of the present invention;

FIG. 7 shows a vehicle-mounted electronic system according to a fifth embodiment of the present invention;

FIG. 8 shows a vehicle-mounted electronic system according to a sixth embodiment of the present invention;

FIG. 9 is a graph that shows the change in an ambient temperature of a group of ECUs between an ignition-on state and a standby mode;

FIG. 10A and FIG. 10B show two ECU examples that have a different function (ability); and

FIG. 11A and FIG. 11B show a difference in responsiveness between the ECUs shown in FIG. 10.

### DETAILED DESCRIPTION OF EMBODIMENTS

Hereinafter, the first to sixth embodiments of the present invention will be described with reference to drawings.

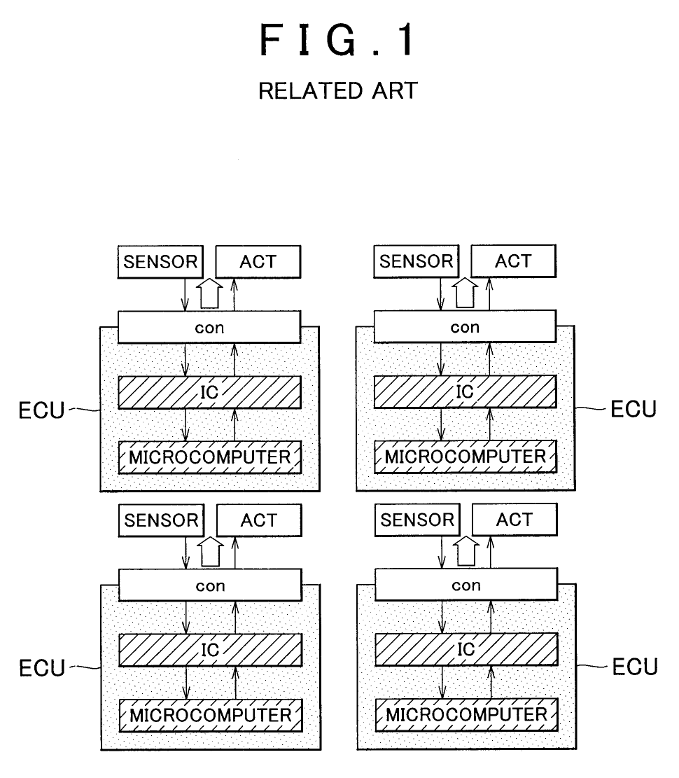

Before the description of the first to sixth embodiments of the present invention, a comparative example is first described with reference to FIG. 1. In the following description, an actuator is not limited to a motor or a solenoid, but may encompass other electric loads such as a lighting device. The sensor includes a switch that outputs on/off signals.

FIG. 1 shows a comparative example (reference example). In the comparative example, four ECUs are each in a standby mode. In the standby mode, a sensor signal is input to each ECU from a corresponding sensor, and the power necessary to operate each sensor/actuator (ACT) in the standby mode and the normal operation mode is supplied by the corresponding ECU. In the above-mentioned constitution, power consumption in the standby mode increases as the number of ECUs, which is in the standby mode, increases, and unfortunately the battery runs down easily.

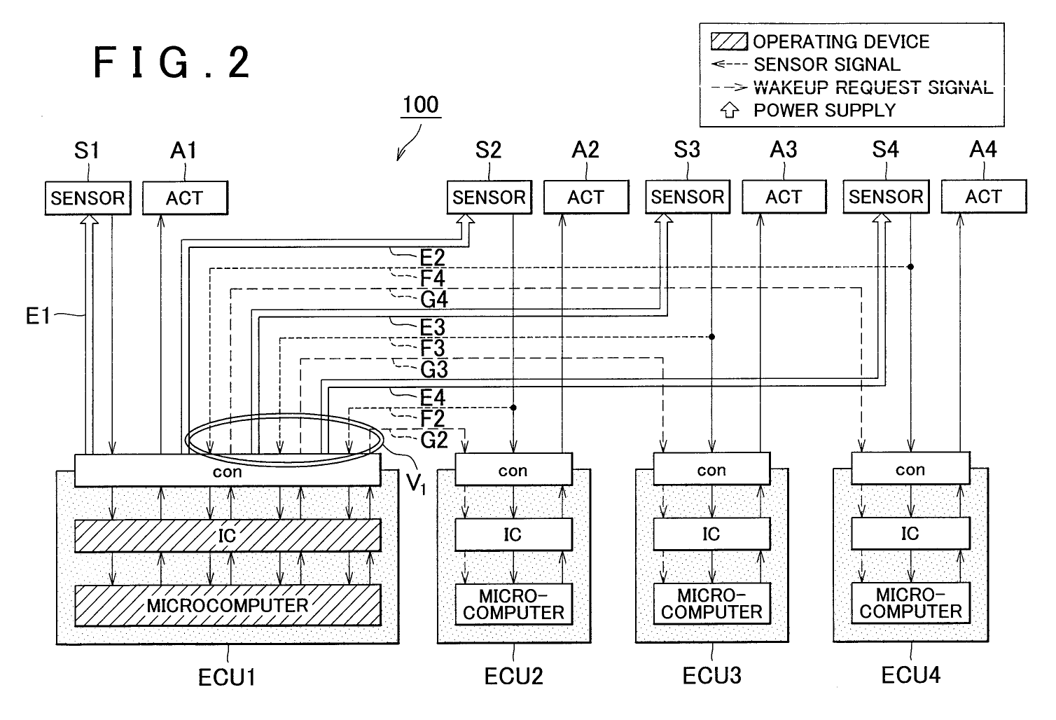

FIG. 2 shows a vehicle-mounted electronic system 100 according to a first embodiment of the present invention. In FIG. 2 and other similar drawings, the microcomputer and the integrated circuit (IC) of the ECU that is powered are distinguished, by hatching, from the microcomputers and ICs of the ECUs that are not powered.

The vehicle-mounted electronic system 100 includes four ECUs, ECU1 to ECU4. ECU 1 is connected to and controls a sensor S1 and an actuator A1. ECU 2 is connected to and controls a sensor S2 and an actuator A2. ECU 3 is connected to and controls a sensor S3 and an actuator A3. ECU 4 is connected to and controls a sensor S4 and an actuator A4.

In the vehicle-mounted electronic system 100 of the present embodiment, one of the four ECUs, in this example, ECU 1, serves as a standby ECU, and the other ECUs 2 to 4 do not operate in the standby mode. In the present embodiment, when the vehicle is in a standby mode, power is only supplied to standby ECU 1, and the standby ECU 1 is in the standby mode. In contrast, the ECUs 2 to 4 are normally in a sleep state or an off state (i.e. power is generally not supplied to the ECU 2, ECU 3, and ECU 4). If necessary, power may be supplied to ECU 2, ECU 3, and ECU 4 to activate the ECUs. Thereby, power consumption in the standby mode may be reduced. When the ignition is turned on, power is supplied to ECUs 1 to 4, and in turn ECUs 1 to 4 respectively supply power the attached sensor and actuator and receive a signal individually from their responsible sensor.

In the standby mode, in the vehicle-mounted electronic system 100, as shown in FIG. 2, the standby ECU 1 receives a sensor signal from a sensor S2, a sensor S3, and a sensor S4 that are controlled by the ECU 2, the ECU 3, and the ECU 4, respectively, through a signal wire F2, a signal wire F3, and a signal wire F4 respectively. The sensor S2, the sensor S3, and the sensor S4 receive power from the standby ECU 1 through a power supply wire E2, a power supply wire E3, and a power supply wire E4 respectively. The standby ECU 1 receives power from a vehicle-mounted battery through a power line (not shown). Therefore, the sensors S2 to S4 receive power from the vehicle-mounted battery through the standby ECU 1. Therefore, the sensors S2 to S4 may be operated in the standby mode, and supply necessary sensor signals to the standby ECU 1. The standby ECU 1 is connected to the ECU 2, the ECU 3, and the ECU 4 through wires G2, G3, and G4 respectively. The standby ECU 1 selectively sends a wakeup request signal, based on the sensor signal, through the wires G2, G3, and G4 to the ECU 2, ECU 3, and ECU 4 respectively.

In the standby mode, the standby ECU 1 monitors the sensor signals from the sensor S2, the sensor S3, and the sensor S4, and when it detects that a certain sensor input is changed (i.e. a prescribed sensor signal is generated), the standby ECU 1 sends a wakeup request signal through the wire G2, the wire G3, or the wire G4 to the ECU 2, the ECU 3, or the ECU 4 based on the change of the sensor input. Accordingly, voltage is applied to the ECU 2, the ECU 3, or the ECU 4, and then the ECU 2, the ECU 3, or the ECU 4 is activated. For example, if sensor S2 is used to detect the approach of a user (specifically, approach of the portable key owned by an appropriate user), and the ECU 2 is used for performing the access light function to drive the actuator A2 (for example a lighting device) to illuminate vehicle surroundings. In this case, if the sensor S2 outputs the sensor signal that indicates the approach of the user to the vehicle, the standby ECU 1 receives the signal and sends a wakeup request signal to the ECU 2 through the wire G2. Correspondingly, the ECU 2 is activated and drives the actuator A2 (lighting device) in order to achieve the access light function to illuminate vehicle surroundings.

In the vehicle-mounted electronic system 100 shown in FIG. 2, the sensor S1 and the actuator A1 are connected to and controlled by the standby ECU 1. However, the standby ECU 1 may not be connected to the sensor S1 and the actuator A1 (i.e. the ECU 1 may be the one that only wakes up the other ECUs). The sensors S1 to S4 and the actuators A1 to A4 may each include a plurality of sensors and actuators. Any number of ECUs may be connected to the ECU 1 is not limitative.

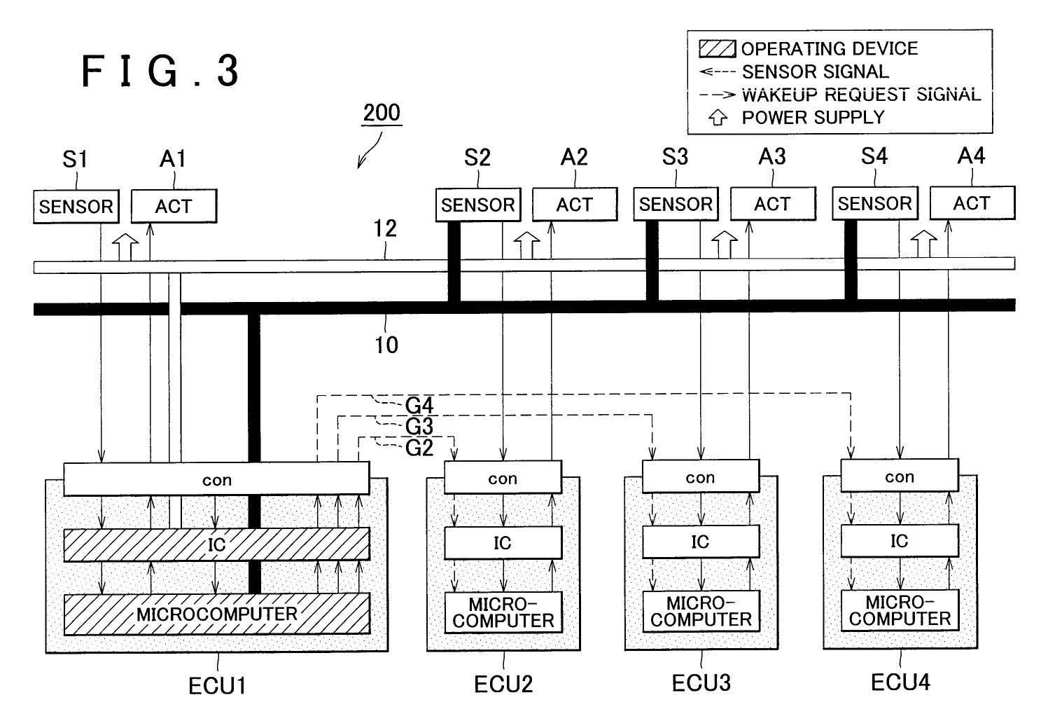

FIG. 3 shows a vehicle-mounted electronic system 200 according to the second embodiment of the present invention. The vehicle-mounted electronic system 200 includes four ECUs 1 to 4. The ECU 1 is connected to and controls a sensor S1 and an actuator A1. The ECU 2 is connected to and controls a sensor S2 and an actuator A2. The ECU 3 is connected to and controls a sensor S3 and an actuator A3. The ECU 4 is connected to and controls a sensor S4 and an actuator A4.

In the vehicle-mounted electronic system 200 of the present embodiment, one of the four ECUs, for example the ECU1, functions as a standby ECU, and the other ECUs 2 to 4 do not require standby operation. Accordingly, power consumption in the standby mode may be reduced because ECUs 2 to 4 are normally set to a sleep state or an off state and activated only when necessary.

The sensors S2 to S4 are all connected to the standby ECU 1 by a signal wire 10 (hereinafter, referred to as “sensor signal wire 10”). As shown in FIG. 3, the sensor signal wire 10 extends from the standby ECU 1 and branches into the sensors S2 to S4, so only a single terminal for connecting the sensor signal wire 10 to the standby ECU 1 is needed. The sensor signal wire 10 is a signal wire (multiplex communication bus) that carries a multiplex signal from the sensor S2, the sensor 3, and the sensor 4 to the standby ECU 1. The sensor signal wire 10 may be implemented by using a LAN (local-area network) for example.

Each of sensors S2 to S4 is also connected to and controlled by the standby ECU1 through a sensor electric wire 12. As shown in FIG. 3, the sensor electric wire 12 extends from the standby ECU 1 and branches into the sensors S2 to S4, so only a single terminal for connecting the sensor electric wire 12 to the standby ECU 1 is needed.

The standby ECU 1 is connected to ECU 2, ECU 3, and ECU 4 through wires G2, G3, and G4, respectively. The standby ECU 1 selectively sends a wakeup request signal through the wires G2, G3, and G4 to the ECU 2, ECU 3, and ECU 4 respectively.

In the vehicle-mounted electronic system 100 according to the first embodiment: shown in FIG. 2, the signal wires F2 to F4 that connect the standby ECU 1 and the respective sensors are needed for ECU 1 to receive sensor signals from the sensors controlled by the ECUs 2 to 4, and also the power supply wires E2 to E4 that carries electric power to the sensors controlled by the ECUs 2 to 4 are necessary. A problem here is that the number of connector PINs (connector number allowance) at the standby ECU 1 causes a bottleneck as indicated by V₁ in FIG. 2.

The vehicle-mounted electronic system 200 according to the second embodiment shown in FIG. 3 uses the sensor signal wire 10 that multiplexes the signals from the sensor S2, the sensor S3, and the sensor S4, so that the signal wire connection terminal of the standby ECU 1 is utilized efficiently. Similarly, the sensor electric wire 12 is commonly used with the sensors S2 to S4, so that the power outlet terminal of the standby ECU 1 may be utilized efficiently.

In the vehicle-mounted electronic system 200 shown in FIG. 3, the sensor S1 controlled by the standby ECU 1 is connected to the sensor electric wire 12. However, the sensor S1 may receive power from the standby ECU 1 independently of the sensor S2, the sensor 83, and the sensor S4. In the vehicle-mounted electronic system 200 shown in FIG. 3, the sensor S1 and the actuator A1 are connected to and controlled by the standby ECU 1. However, the standby ECU 1 may not be connected to the sensor S1 and the actuator A1 (i.e. the ECU 1 may be the one that only wakes up other ECUs). The sensors S1 to S4 and the actuators A1 to A4 may each include a plurality of sensors and actuators. The any number of ECUs connected to the standby ECU 1 as appropriate.

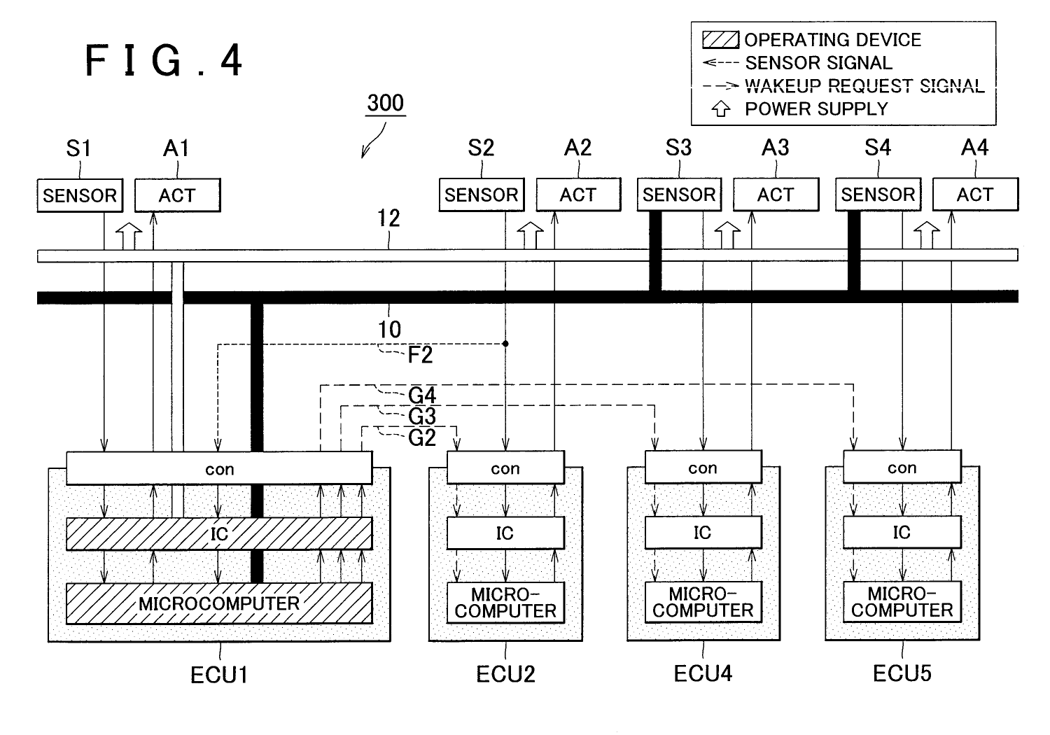

FIG. 4 shows a vehicle-mounted electronic system 300 according to the third embodiment of the present invention. The third embodiment is a combination of the first embodiment and the second embodiment.

The vehicle-mounted electronic system 300 includes four ECUs, ECU 1 to ECU 4. The ECU 1 is connected to and controls a sensor S1 and an actuator A1. The ECU 2 is connected to and controls a sensor S2 and an actuator A2. The ECU 3 is connected to and controls a sensor S3 and an actuator A3. The ECU 4 is connected to and controls a sensor S4 and an actuator A4.

In the vehicle-mounted electronic system 300, one of the four ECUs, for example the ECU1, functions as a standby ECU, and the other ECUs 2 to 4 do not function as a standby ECU. Accordingly, power consumption in the standby mode may be reduced because the ECUs 2 to 4 are normally set to a sleep state or an off state and activated only when necessary.

The sensors S3 and S4 are both connected to the standby ECU1 through the sensor signal wire 10. The sensor signal wire 10 multiplexes the signals from the sensor S3 and the sensor S4. In contrast, the ECU 2 is connected to the standby ECU 1 through the signal wire F2 instead of the sensor signal wire 10.

The sensors S2 to S4 that are controlled by the ECUs 2 to 4 are mutually are both connected to the standby ECU1 through the sensor electric wire 12. The sensor electric wire 12 extends from the standby ECU 1 and branches into the sensor S2, the sensor S3, and the sensor S4.

The standby ECU 1 is connected to ECU 2, ECU 3, and ECU 4 through corresponding wires G2, G3, and G4 respectively. The standby ECU 1 selectively sends an activation signal through the wires G2, G3, and G4 to ECU 2, ECU 3, and ECU 4 respectively.

In the vehicle-mounted electronic system 200, sensor signals from the sensor S2, the sensor S3, and the sensor S4 are multiplexed and then input to the standby ECU 1. Therefore, depending on the traffic condition of the sensor signal wire 10, there may be a delay before the sensor signal is input to the standby ECU 1. Such a delay may be harmful for the function that requires high responsiveness.

In the vehicle-mounted electronic system 300 shown in FIG. 4, the sensor signals front the sensors S3 and S4 are input to the ECU 1 as a multiplexed signal, and the sensor signal from the sensor S2 is directly input to the standby ECU 1. Thus, the standby ECU 1 can promptly respond to the sensor signal from the sensor S2. In this way, the sensor signal of a function that requires high responsiveness is directly input to the standby ECU 1, and the sensor signal of functions that do not require high responsiveness are multiplexed before being input to the standby ECU 1. Accordingly, the necessary responsiveness may efficiently be maintained without requiring an excessive number of connectors. For example, the sensor signal of the access light function described above or the sensor signal of the monitoring function on certain vehicle systems in the standby mode (for example, the pressure of the fuel tank after a predetermined time period has elapsed since the engine was turned off) may be input to the standby ECU 1 as a multiplexed signal, and the sensor signal of the smart entry system (for example door lock and engine push start) and a human machine interface (HMI) is directly input to the standby ECU 1.

As described above, some of the signals from the sensor S2, the sensor S3, and the sensor S4 that receives power from the standby ECU 1 in the standby mode are input to the standby ECU 1 as a multiplexed signal (for example by connecting the sensor S2, the sensor S3, and the sensor S4 to the ECU 1 through a LAN). Accordingly, the number of connectors of the standby ECU 1 is not excessive and the necessary responsiveness may be maintained.

Whether the ECU 1 and the sensors are directly connected or the ECU 1 and the sensors are multiplexingly connected may be selected based on the required response speed in responding to each sensor information (i.e. a period of time from the change of sensor output to the wakeup point). In this case, the choice between the direct connection and multiplex connection can be logically determined by comparing the following three factors: (1) the required response speed of each sensor; (2) the response speed threshold of the LAN configuration in consideration of each sensor's ability to respond to the LAN (LAN output responsiveness) and the number of nodes of the LAN bus; and (3) the number of channels (the number of terminals) that the standby ECU 1 can accept.

In the vehicle-mounted electronic system 300 shown in FIG. 4, the sensor S1 controlled by the standby ECU 1 is connected to the sensor electric wire 12. However, the sensor S1 may receive power from the standby ECU 1 independently of the sensor S2, the sensor S3, and the sensor S4. In the vehicle-mounted electronic system 300 shown in FIG. 4, the sensor S1 and the actuator A1 are connected to and controlled by the standby ECU 1. However, the standby ECU 1 is not necessarily connected to the sensor S1 and the actuator A1 (that is, the ECU 1 may be serve only to wakes other ECUs). The sensors S1 to S4 and the actuators A1 to A4 may each include a plurality of sensors and actuators. The any number of ECUs may be connected to the ECU 1 as necessary.

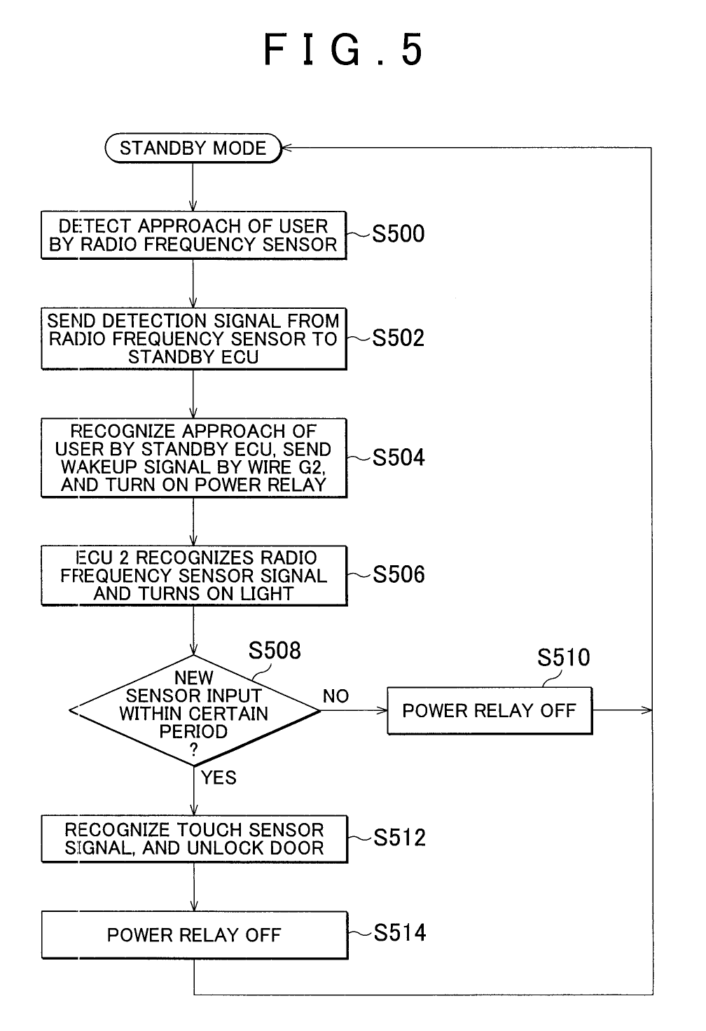

FIG. 5 is a flow chart that shows an example of the main process executed by the vehicle electronic systems 100, 200, and 300 according to the first to third embodiments described above. As an example, the execution of the process will be described in the context where a user approaches and enters the vehicle while the vehicle is in the standby mode.

The ECU 2 controls the access light function, which illuminates the interior of the vehicle when the user is entering the vehicle, and the functions related to a smart entry system. The smart entry system communicates using weak radio waves between a transceiver (radio frequency sensor) installed in the vehicle and the portable key, detects that a person approaching to the vehicle is an appropriate user by verifying an ID code of the portable key, detects the operation on the door outer handle, and then unlocks the door of the vehicle. The communication is also performed when the user sits in the seat. If the ID code of the portable key is verified and the operation on the engine switch is detected, the smart entry system starts the engine (this action is referred to as “engine push start”). The sensor S2 includes, a sensor (radio frequency sensor) that detects the approach of appropriate user to the vehicle, and a sensor (touch sensor) that detects the operation of the outside door handle. The actuator A2 controlled by the ECU 2 includes, a illumination device, and a door lock actuator.

In step 500, the radio frequency sensor (e.g., sensor S2) detects that the user is approaching the vehicle. The radio frequency sensor, as described above, communicates with the portable key through weak radio waves, and detects the approach of user by verifying the ID code of a portable key.

In step 502, the radio frequency sensor transmits, to the standby ECU 1, a detection signal that indicates the approach of user. In the vehicle-mounted electronic systems 100 and 300, the detection signal is sent through the signal wire F2 to the standby ECU 1. In the vehicle-mounted electronic system 200, the detection signal is sent through the sensor signal wire 10 (LAN) to the standby ECU 1.

In step 504, the standby ECU 1 recognizes the approach of the appropriate user, sends a wakeup request signal through the wire G2, and turns on the power supply relay that communicate the ECU 2 and the battery (not shown). Accordingly, power is supplied to the ECU 2, thereby activating the ECU 2 (turned on).

In step 506, the ECU 2 recognizes the detection signal of the radio frequency sensor again, and drives and turns on the light (one of the actuator A2). The ECU 2 may turn on the light automatically at nighttime when power is supplied from the standby ECU 1 to the ECU 2 (i.e. when the ECU 2 is awake).

In step 508, the standby ECU determines whether a sensor signal is newly input within a prescribed period after the detection signal is input from the radio frequency sensor. If no sensor signal is input within the prescribed period, the process proceeds to step 510, and the power supply relay is turned off through the wire G2. Then, the ECU 2 returns to a sleep (off) state again. However, if the user touches the outer door handle, the touch sensor (one of the sensor S2) detects the action. The detection signal is directly recognized by the ECU 2 that is already activated or in a standby mode. In this case, the process proceeds to step 512, in which the ECU 2 drives the door lock actuator (one of the actuator A2) to unlock the door.

In step 514, the standby ECU 1 turns off the power supply relay through the wire G2. In this case, the standby ECU 1 may turn off the power supply relay through the wire G2 when a predetermined period has elapsed after the door lock actuator is driven or the ignition is turned on. This is acceptable because the ECU 2 needs to fulfill the rest of the functions (for example engine push start) related to the smart entry system after the user gets in the vehicle. In this case, the ECU 2 may be woken up again with the similar aspect, being triggered by the detection of engine switch operation after a prescribed period has elapsed from when the door lock actuator is driven (that is after the power supply relay is turned off).

In the description related to FIG. 5, the ECU 2 controls the access light function to provide illumination when the user gets in the vehicle and also controls the smart entry system related functions. However, the ECU 2 may be limited to controlling the access light function, and the ECU 3 may instead control the smart entry system related functions. In this case, the ECU 2 and the ECU 3 may both be woken up in step 504 described above. Or, if required responsiveness can be satisfied, the ECU 3 may be woken up when the detection signal of the touch sensor related to the step 512 is received.

In the description relating to FIG. 5, the wakeup request signal is used for supplying power in order to turn on the power supply relay. However, the wakeup request signal may be used to turn on a semiconductor-switching element (for example transistor). In this case, the semiconductor switching element is disposed on a power supply line that connects each of the ECU 2, the ECU 3, and the ECU 4 to the battery (not shown), and is normally turned off (to a non-conductive state) in the standby mode.

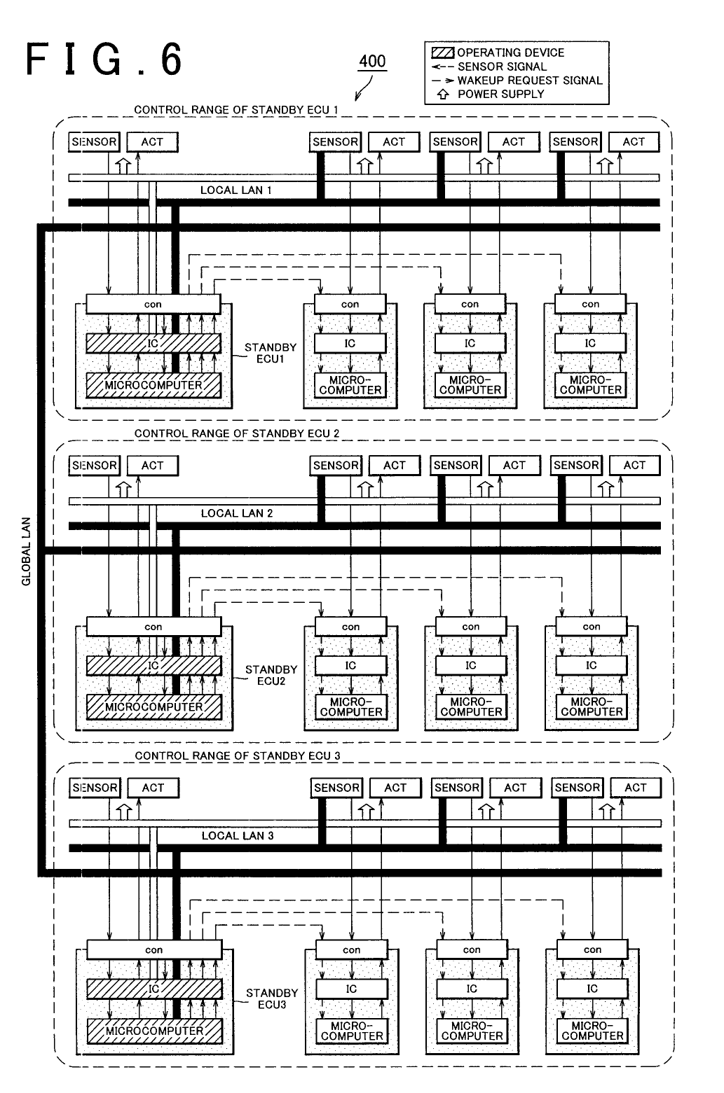

FIG. 6 shows a vehicle-mounted electronic system 400 according to a fourth embodiment of the present invention. In the vehicle-mounted electronic system 400, a plurality of ECUs (three ECUs in the present embodiment) function as standby ECUs 1, 2, and 3, and the ECUs 1, 2, 3 each have their own control range. In the control range of the standby ECUs, 1, 2, and 3, for example, there are provided three ECUs (corresponding to the ECUs 2 to 4 in the vehicle-mounted electronic system 200 according to the second embodiment) and the sensor and the actuator controlled by the three ECUs (corresponding to the sensors S2 to S4 and the actuators A2 to A4 in the vehicle-mounted electronic system 200 according to the second embodiment). Constitution in the control range is the same as the vehicle-mounted electronic system 200 shown in FIG. 3. However, the constitution may be the same as the one shown in FIG. 2 and FIG. 4. The control range may be determined by factors such as installation position and arrangement. Typically, an ECU that is installed near the standby ECU is included in the control range of the standby ECU. For example, the ECU installed on the right side of an instrumental panel may be included in the control range of the standby ECU installed on the right side of the instrumental panel, and the ECU installed on the left side of the instrumental panel may be included in the control range of the standby ECU installed on the left side of the instrumental panel.

In the vehicle-mounted electronic system 400, the standby ECUs 1, 2, and 3 wake up (fully operate) other ECUs in their own control range, as described above, based on the sensor signal in their own control range, but do not wake up the ECUs outside of the own control range.

In the vehicle-mounted electronic system 400, a sensor signal wire (LAN) in each control range is locally constituted within each control range. In other words, a local LAN 1 is dedicated to the control range of the standby ECU 1, a local LAN 2 is dedicated to the control range of the standby ECU 2, and a local LAN 3 is dedicated to the control range of the standby ECU 3. The local LANs 1, 2, and 3 are not connected with each other. The reason is that if local LANs 1, 2, and 3 are connected with each other, the sensor signal that travels on the local LANs 1, 2, and 3 may potentially actuates the standby ECU in other control ranges. A global LAN that connects a whole network is separately provided. The global LAN is an ordinary vehicle-mounted LAN that carries various signals mainly in a non-standby mode (ignition-on state).

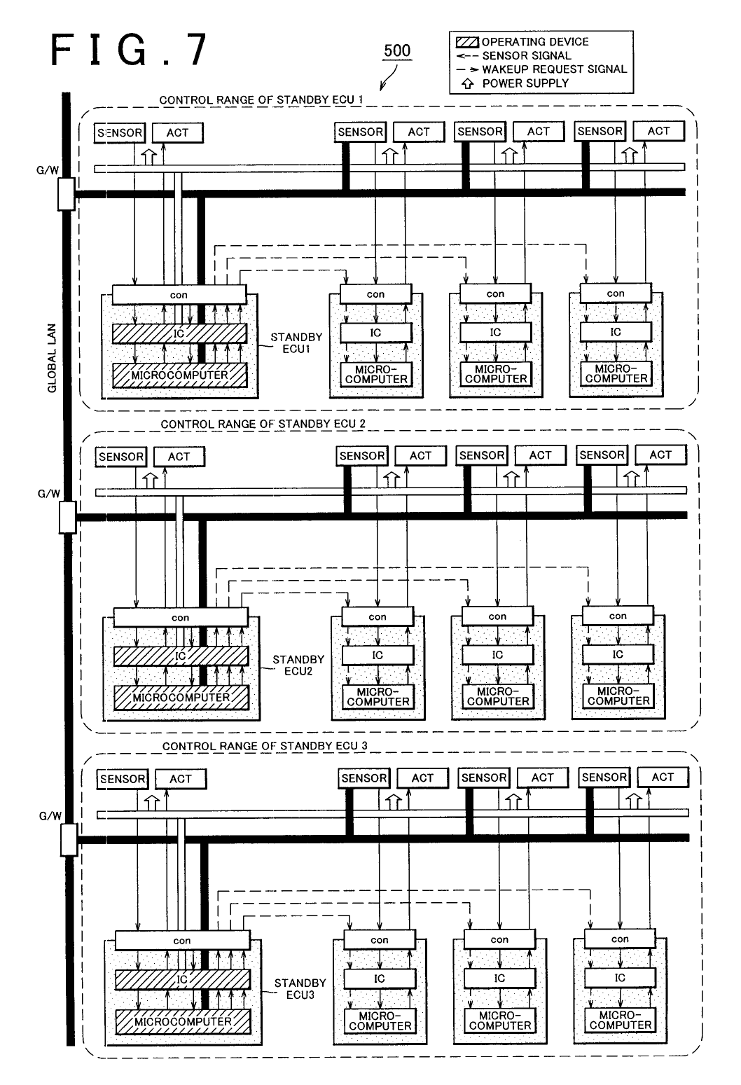

FIG. 7 shows a vehicle-mounted electronic system 500 according to a fifth embodiment of the present invention. In the vehicle-mounted electronic system 500, a global LAN is connected to each control range through a gateway G/W instead of the local LANs 1, 2, and 3 of the vehicle-mounted electronic system 400 shown in FIG. 6. In this case, an ID that shows the control range and a message that shows wakeup are not allowed to pass through the gateway G/W, so that an ordinary vehicle-mounted LAN (multiplexing) can be utilized while interference between the control ranges can be prevented.

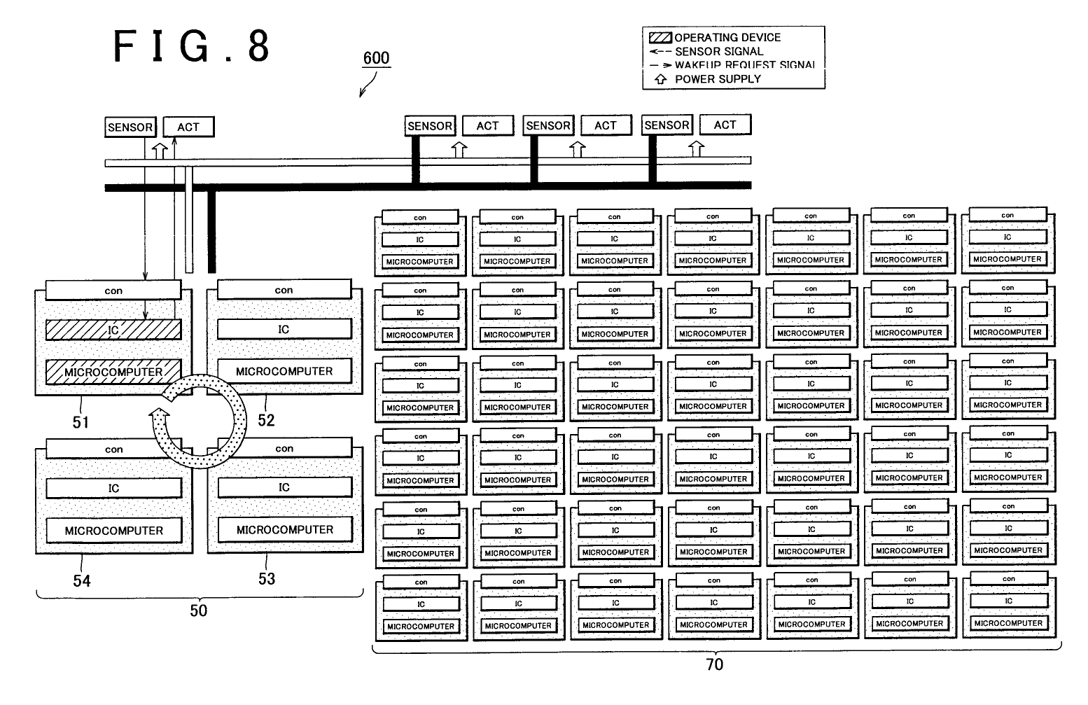

In the embodiments described above, the standby ECU is fixed and not interchange able with another ECU. In the configurations of the embodiments described above, when various standby operations are required simultaneously, the microcomputer process capacity required in the standby mode increases, and as a result, the standby ECU consumes a lot of power (in general, the microcomputer with greater processing power has higher dark current). The standby ECU is normally conductive and normally operative. If the standby ECU is fixed, a period of time in which reliability of the standby ECU is maintained becomes shorter. In the embodiments shown in FIG. 8 and later, as a countermeasure to such a problematic cases, the role of the standby ECU may be rotated between a plurality of ECUs.

FIG. 8 shows a vehicle-mounted electric system 600 according to a sixth embodiment of the present invention. The vehicle-mounted electric system 600 differs from the vehicle-mounted electric system 200 in that the role of the standby ECU rotated between ECUs 51 to 54 of the ECU group 50. In the state shown in FIG. 8, power is supplied to the ECU 51, and the ECU 51 functions as a standby ECU. At this time, power is not supplied to the ECU 52, the ECU 53, and the ECU 54, and thus the ECU 52, the ECU 53, and the ECU 54 are bought into a sleep state. An ECU group 70 is equivalent to the ECUs 2 to 4 in the vehicle-mounted electric system 200 according to the second embodiment.

In the vehicle-mounted electric system 600, as shown by the arrow in FIG. 8, when a certain event happens, the standby ECU switches between the ECUs in the ECU group 50, for example, from the ECU 51 to the ECU 52 and then from the ECU 52 to the ECU 53. Accordingly, a semiconductor reliability period (that is, Means Time Between Failure (MTBF)) may be extended and power consumption may further be reduced. The switching order is not restricted to the clockwise sequence shown in the drawing but may be any order.

The following description shows some examples of a switching method (pattern) of the standby ECU in the vehicle-mounted electric system 600 in FIG. 8.

As a first standby ECU switching method, the standby ECU may be switched based on time. For example, an extended period of time, 90 days for example, may be set as an interval, and at the end of the interval the function of “standby ECU” assigned to mother ECU (for example, in the example shown in FIG. 8 the standby ECU is switched from the ECU 51 to the ECU 52). Specifically, the ECU as a standby ECU starts counting when it first becomes active. A short period of time is counted by hardware, and when the short period of time runs out, then a long period of time is counted by software. In this case, the role of the standby ECU may deadlock if the operating standby ECU stops due to noise or when the function cannot be switched (shifted) well. For this reason, the role of the standby ECU may be shifted based not only on time but also events such as ignition-on and ignition-off in order to improve reliability. Such functional switching with a long-term interval prevents the semiconductor from deteriorating and improves reliability of the ECU.

As a second standby ECU switching method, the standby ECU may be switched based on the ambient temperature of the ECU group 50. The ambient temperature of the ECU group 50 may be detected by the temperature sensor, and the temperature sensor may be disposed on the inner wall etc of a housing in which the ECU group 50 is installed.

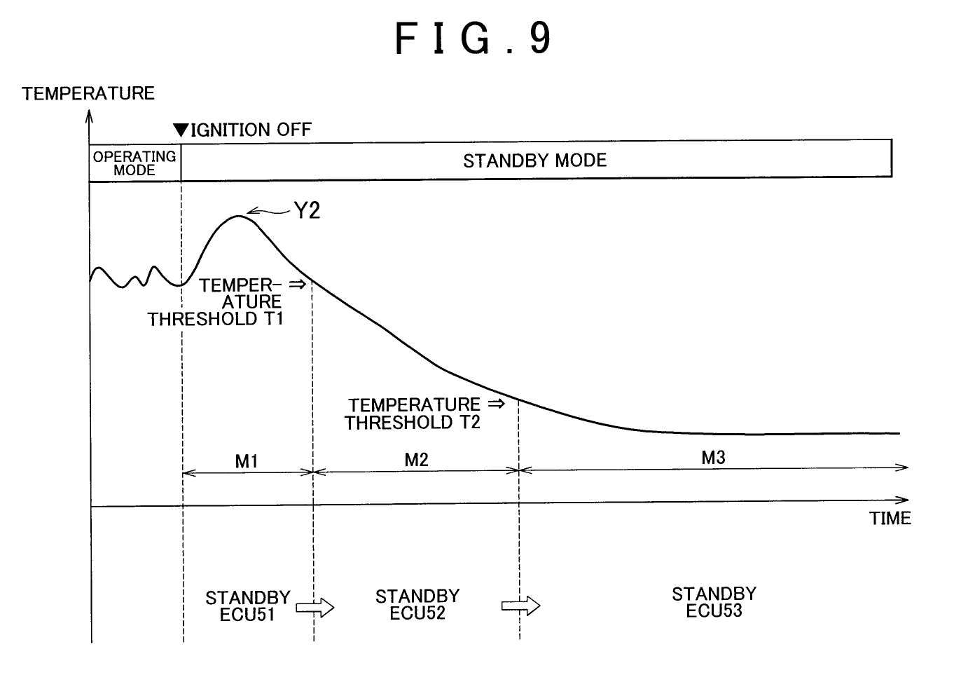

FIG. 9 is a graph that shows the change in an ambient temperature of a group of ECUs between an ignition-on state and a standby mode.

As shown in FIG. 9, the ambient temperature of the ECU group 50 maintains a steady high temperature during operation of the ECU group 50 (i.e. while the ignition is turned on). However, when the ignition is turned off, a cooling capacity drops immediately, and the temperature increases for a short while as indicated by Y2 in FIG. 9. A dark current of the semiconductor generally has a distinctive temperature characteristic, and tends to increase sharply in a high temperature range.

As a specific example of a second standby ECU switching method, the ECU 51, which includes a microcomputer with low power consumption and low processing power, is used as a standby ECU in a high temperature range M1, which indicates a short period of time immediately after the ignition-off. The ECU 51 may be the one that only performs simple standby operation because it does not consume much power and is a low processing power. When the temperature drops below the temperature threshold T1 (in the case of range M2), the standby ECU is switched from the ECU 51 to the ECU 52. The ECU 52 may have higher processing power than the ECU 51. If the temperature further drops to be lower than temperature threshold T2 (in the case of range M3), the standby ECU is switched from the ECU 52 to the ECU 53. The ECU 53 has higher processing power than the ECU 51 and the ECU 52. In the ECU 53, operation current consumption and dark current are both considerably low in a substantially room temperature range of the temperature threshold T2 or lower. Thus, power consumption by the standby operation can be reduced. In the example shown above, the standby ECU is switched between three ECUs 51, 52, and 53. However, the standby ECU may be switched between two ECUs 51 and 53, or may be switched between four or more ECUs. The threshold temperatures T1 and T2 may be defined as variables that may differ depending on vehicle model, and these variables may be adapted to suitable values for the vehicle model. Accordingly, the ECU group 50 may be used in different vehicle models. In other words, general versatility is improved.

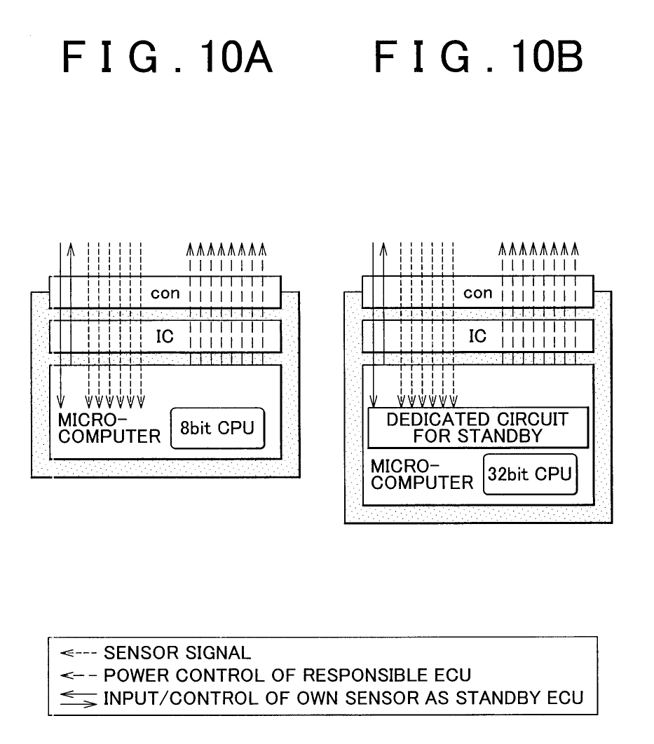

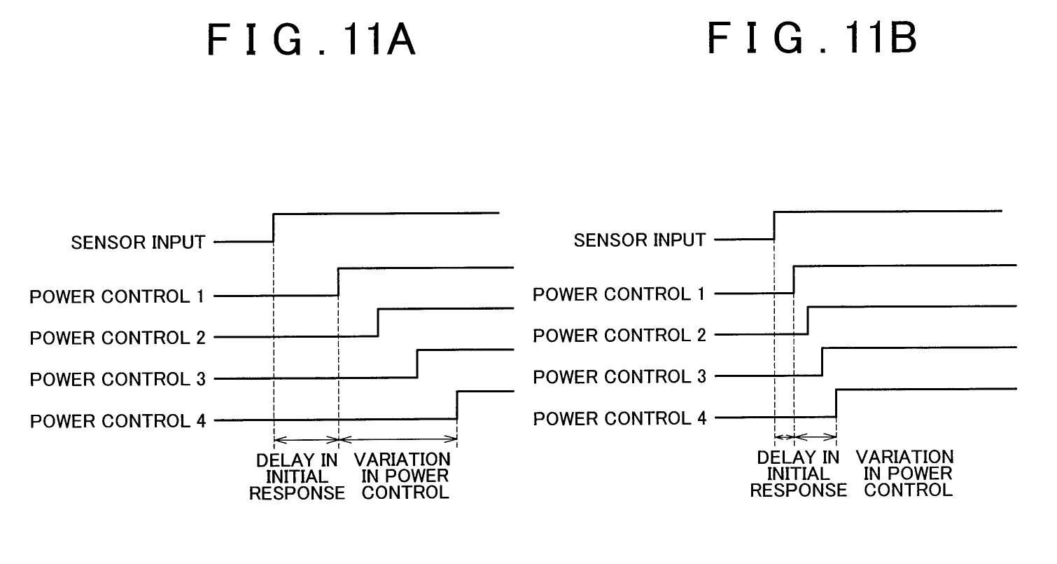

Here, the ECU 51, which has low power consumption and low processing power, and the ECU 53, which has high processing power, are shown in FIG. 10A and FIG. 10B, respectively. The ECU shown in FIG. 10A is used as the ECU 51 and provided with an 8-bit CPU. The ECU shown in FIG. 10B is used as the ECU 53 and provided with a 32-bit CPU and a circuit dedicated to standby function. The ECU shown in FIG. 10A has a low performance CPU and does not have a dedicated circuit. Accordingly, the ECU shown in FIG. 10A there is a long delay (in initial response) between detection of the change in sensor input to waking up other corresponding ECUs, and causes delays in the power control timing to wake up a plurality of ECUs. However, the ECU shown in FIG. 10B includes a high-performance CPU and a dedicated circuit. In contrast, as shown in FIG. 11B, the delay in initial response by the ECU shown in FIG. 10B from detecting the change in sensor input to waking up other corresponding ECUs is shorter, and thus the delays in the power control timing to wake up a plurality of ECUs is reduced. Therefore, the ECU of FIG. 10A may be used as the ECU 51 for simple standby operation where the subject (such as inner pressure of the fuel tank) is monitored with a 100 ms cycle, which does not require a high-performance CPU, for a few minutes when the ambient temperature around the ECU is high, in the standby mode. In contrast, the ECU of FIG. 10B may be used as the ECU 53 to monitor the sensor output during standby mode with a short cycle of several milliseconds in order to make precise diagnosis.

In the second standby ECU switching method described above, the role of the standby ECU is switched by detecting the ambient temperature of the ECU group 50. However, the temperature drop profile when the ignition is turned off tends to be substantially identical each time the ignition is turned off. For this reason, the switch timing may be determined by time based on the temperature drop profile. That is, the timing, in which the ambient temperature of the ECU group 50 is reduced to be lower than the temperature thresholds T1 and T2 (time after ignition-off), may be obtained from the temperature drop profile. Then, the role of the standby ECU may be switched based on the timing. According to this method, the sensor that detects the ambient temperature of the ECU group 50 may be omitted because the switching function can be fulfilled by the timer of the microcomputer, and thus the component cost may be reduced. Alternatively, the switch timing may be set differently in accordance with the vehicle model as appropriate for each vehicle model. Accordingly, the ECU group 50 can be used in many vehicle models. In other words, general versatility is improved.

As a third standby ECU switching method, the role of the standby ECU may be switched after a prescribed period has elapsed from when the ignition is turned off.

As a fourth standby ECU switching method, the role of the standby ECU may be switched each time the ignition is turned off. In this case, the timer is not necessary, and a deadlock in ECU switching may be avoided because the ignition is operated by the user.

These methods are especially effective when used in combination. For example, the third standby ECU switching method and the fourth standby ECU switching method, while acting alone, cannot be suited to the situation where the ignition of the vehicle cannot be turned off for a long time. However, if the methods are combined with the first standby ECU switching method, defects are covered by each other, and as a result, the method can function effectively.

The following table shows assumed effects and the like related to the first to fourth standby ECU switching methods described above.

TABLE 1

| | | | | OPERABLE | | |
|---|---|---|---|---|---|---|
| | | EFFECT | | FUNCTION | | |
| | | Power | | | Tem- | |
| | | consumption | MTBF | | perature | User |
| No | Item | reduction | extension | Timer | sensor | event |
| 1 | Long cycle | | ∘ | ∘ | | |
| | time | | | | | |
| 2 | Ambient | ∘ | ∘ | | ∘ | |
| | temperature | | | | | |
| | of ECU | | | | | |
| 3 | Short cycle | ∘ | ∘ | ∘ | | |
| | time after | | | | | |
| | ignition-off | | | | | |
| 4 | Ever ignition- | ∘ | | | ∘ | |
| | off | | | | | |

The first to sixth embodiments have been described above. However, the present invention is not restricted to the described embodiments. Various modifications and substitutions may be made to the embodiments without deviation from the scope of the present invention.

For example, in the above embodiments, the ECUs that should be operated in the standby mode are all woken up by the standby ECU. However, part of the ECUs to be operated in the standby mode may be the type of ECU shown in FIG. 1.

In the above embodiments, power may be supplied to each individual actuator through its controlling ECU. Alternatively, power may be supplied to the actuator by the same embodiment as the sensor.

In the above embodiments, power is always supplied from the standby ECU to all the sensors that are controlled by the other ECUs. However, power supply to part of the sensors may temporarily be performed, for example by a relay, or using a wire that is independent of other wires connected to the other sensors. For example, if the inner pressure of the fuel tank is monitored, the elapsed time may be measured by the standby ECU, and power may be temporarily supplied to the evaporation sensor (pressure sensor) after a prescribed time has elapsed. In this case, power does not need to be continuously supplied to the evaporation sensor, so that power consumption may further be reduced.

In the above embodiments, only the access light function performed by lighting devices is described. However, the functions to be fulfilled in the standby mode are not limited in any way. For example, as another example of access function, when approach of user to the vehicle is detected, a mirror retraction actuator, a seat positioning actuator, and a steering positioning actuator may be driven so as to adjust a mirror position, a seat position, and a steering position that are customized to the user. Also, a security function may be implemented through the present invention by using a sensor (an acceleration sensor, an infrared sensor, etc) that detects impact or intrusion to the vehicle. For example, if a suspicious event happens to the vehicle, a buzzer (one example of the actuator) may ring as a warning and the suspicious event may be reported to the user's cell phone.

What is claimed is:

1. A vehicle-mounted electronic system comprising,
a plurality of sensors in which at least two sensors continue to operate after an ignition is turned off; and
a plurality of ECUs, wherein:
a power supply wire and a signal wire of the at least two sensors are connected to at least one ECU of the plurality of ECUs;
a number of the at least one ECU is less than a number of ECU of the plurality of ECUs that is operated when the ignition is turned on; and
the at least one ECU functions as a standby ECU when the ignition is turned off.

2. The vehicle-mounted electronic system according to claim 1, wherein part of the plurality of sensors is connected through a LAN to the standby ECU.

3. The vehicle-mounted electronic system according to claim 1, wherein
the standby ECU monitors an input signal from the plurality of sensors, and activates at least one ECU from among the remainder of the plurality of ECUs that are in a sleep state or a off state when the ignition is turned off, in accordance with the input signal from the sensors.

4. The vehicle-mounted electronic system according to claim 1, wherein at least two ECUs alternately function as the standby ECU in predetermined pattern.

5. The vehicle-mounted electronic system according to claim 4, wherein the predetermined pattern is determined in accordance with at least on of time, temperature, and whether the ignition is off.

6. The vehicle-mounted electronic system according to claim 1, wherein the sensor is at least one of a radio frequency sensor for detecting a portable key, a physical contact sensor or an operation sensor switch disposed on a door handle or a door lock button; an evaporation sensor; a shock sensor; and an intrusion sensor.

7. A vehicle-mounted electronic system comprising:
a standby ECU that enters a standby mode when ignition is turned off;
a plurality of non-standby ECUs that are respectively connected to a plurality of sensors that are operated when the ignition is turned off, wherein the non-standby ECU is in a sleep state or an off state when the ignition is turned off;
a sensor electric wire that connects the plurality of sensors to the standby ECU and through which power is supplied from the standby ECU to the plurality of sensors;
a sensor signal wire that carries a signal from the plurality of sensors to the standby ECU; and
an ECU signal wire that connects the plurality of non-standby ECU to the standby ECU, wherein the ECU signal wire carries a wakeup request signal from the plurality of standby ECU to the non-standby ECU,
wherein the standby ECU, in response to signal input from the sensor, transmits the wakeup request signal through the ECU signal wire to the non-standby ECU based on the signal from the sensor.

8. The vehicle-mounted electronic system according to claim 7, wherein at least two ECUs alternately function as the standby ECU in predetermined pattern.

9. The vehicle-mounted electronic system according to claim 8, wherein the predetermined pattern is determined in accordance with at least on of time, temperature, and whether the ignition is off.

10. The vehicle-mounted electronic system according to claim 7, wherein a signal through at least part of the sensor signal wire is multiplexed in relation to the plurality of sensors.

11. The vehicle-mounted electronic system according to claim 7, wherein the sensor is at least one of a radio frequency sensor for detecting a portable key, a physical contact sensor or an operation sensor switch disposed on a door handle or a door lock button; an evaporation sensor; a shock sensor; and an intrusion sensor.

12. The vehicle-mounted electronic system according to claim 7, wherein:
the non-standby ECU is connected with an electric load in addition to the sensor; and
the electric load is that of at least one of a mirror retraction actuator, a door lock actuator, a seat positioning actuator, a steering positioning actuator, and a lighting device.
